(19) United States
(12) Patent Application Publication
(10) Pub. No.: US 2013/0042247 A1
(43) Pub. Date: Feb. 14, 2013

(54) Starvationless Kernel-Aware Distributed Scheduling of Software Licenses

(71) Applicants: Martin D. Carroll, Watchung, NJ (US); William Katsak, Piscataway, NJ (US)

(72) Inventors: Martin D. Carroll, Watchung, NJ (US); William Katsak, Piscataway, NJ (US)

(73) Assignee: ALCATEL-LUCENT USA INC., Murray Hill, NJ (US)

(21) Appl. No.: 13/207,810

(22) Filed: Aug. 11, 2011

(51) Int. Cl. G06F 9/46

(52) U.S. Cl. 718/102

(57) ABSTRACT

Methods, systems, and apparatuses for implementing shared-license management are provided. Shared-license management may be performed by receiving from a remote client a license request to run a process of a shared-license application; adding the process to a queue maintained for processes waiting for license grants; and reserving at least one license instance for the received license request, the at least one license instance comprising a quantum of CPU time for running the process.

### FIELD OF THE INVENTION

The present invention is generally directed to distributed scheduling of software licenses in a shared-license management system.

### BACKGROUND

For multitasking computer systems, the term “starvation” describes the problem condition where a process is denied necessary resources for an extended period of time, or even perpetually. In particular, starvation is a problem for licensed software programs, where client users may have to share a limited number of licenses granting access to a shared-license application. Typically, in such shared-license application systems there are generally three forms of starvation that may occur when two users, A and B, require the use of a shared-license application.

The first form of starvation can be referred to as a greedy running process (GRP). In a GRP scenario, User A may start a long-running license-holding job at time t₀. Shortly thereafter, at time t₁, user B may want to start a job that needs the same license instance as user A. Before user B can begin, however, it must wait for a potentially long time, until user A finishes at time t₂.

The second form of starvation can be referred to as a greedy idle process (GIP). The GIP scenario occurs when an application is idle while holding a license. For example, user A may start a license-holding application at time t₀ and then stop using the application without terminating it. User B, again wanting to access the application at time t₁, must wait for a potentially long time (or indefinitely) until user A terminates the application before beginning at time t₂.

The third form of starvation can be referred to as a greedy dead process (GDP). If an application holding a license unexpectedly (or expectedly) dies before it gets a chance to return the license, the license will be unavailable until someone—either a user of the system or the license system itself—realizes that the application has died and takes the necessary steps to recover its licenses.

The problem of sharing a limited number of software licenses among a large number of applications is analogous to the classic operating system (OS) problem of sharing limited resources among a large number of processes, while guaranteeing that no process starves waiting for a resource. In the case of software licenses, however, an obstruction to solving the starvation problem at the OS level is that the various machines whose processes share a given license know nothing about the license requirements of processes executing on other machines. Therefore, the end user may have no way to work around a poorly behaving application, short of not executing it in the first place.

### SUMMARY

A shared-license management system and method is proposed. In one embodiment, shared-license management may be performed by receiving from a remote client a license request to run a process of a shared-license application; adding the process to a queue maintained for processes waiting for license grants; and reserving at least one license instance for the received license request, the at least one license instance comprising a quantum of CPU time for running the process. In accordance with an embodiment, the process may be added to the rear of the queue, and the queue may be ordered according to an any-out method where processes requesting licenses are not moved with respect to each other.

In accordance with an embodiment, shared-license management may comprise maintaining a reservation set and a need set for each process in the queue, wherein the reservation set includes all reserved licenses for the process and the need set includes all received license requests for the process; determining from the need set at least one license instance that the process needs but has not yet had reserved; and reserving a plurality of license instances for the requesting process based on the process's need set.

In accordance with an embodiment, shared-license management may comprise removing the process from the queue when the process's reservation set matches the process's need set; and issuing a grant including the at least one license instance to the remote client.

In accordance with an embodiment, shared-license management may comprise determining whether the process has become idle and, if the process has been idle for a time that exceeds a pre-selected value, relinquishing all of the reserved license instances for the process.

In accordance with an embodiment, shared-license management may comprise reissuing the reserved license instances to the process when the process becomes non-idle.

In accordance with an embodiment, shared-license management may comprise determining whether the process has terminated and, if so, relinquishing all of the reserved license instances for the process.

In accordance with an embodiment, shared-license management may comprise idling the process until it is issued a grant for the licenses it needs.

These and other advantages will be apparent to those of ordinary skill in the art by reference to the following detailed description and the accompanying drawings.

### BRIEF DESCRIPTION OF THE DRAWINGS

FIG. 1 shows application usage timelines illustrating starvation and non-starvation between users of a shared-license management system;

FIG. 2 is an exemplary diagram showing the architecture of a shared-license management system in a networked computing environment according to an embodiment;

FIG. 3 is a flowchart showing the steps taken for an invocation of the global scheduling algorithm;

FIG. 4 is a global scheduler event-processing table that may be used for implementing a shared-license management system;

FIG. 5 is a local scheduler event-processing table that may be used for implementing a shared-license management system;

FIG. 6 is a flowchart showing the steps taken for implementing a shared-license management system in a networked computing environment; and

FIG. 7 is a high-level block diagram of an exemplary computer that may be used for implementing a shared-license management system.

### DETAILED DESCRIPTION

A shared-license management system and method can help to ameliorate the starvation scenarios experienced in check-out, check-in (COCI) based software management systems. In a shared-license management system, application licenses are treated as resources and the license-management system as a single distributed resource scheduler. The shared-license management system comprises a global scheduler that runs on a server and schedules license instances to remote processes, and a local scheduler, in communication with the global scheduler, that runs on one or more clients and schedules local processes to client CPUs.

In one embodiment, licensed applications may inform the local scheduler whenever they need a license, or when they are finished needing a license. For example, the local scheduler may establish and dynamically modify a current need set for licensed applications. The local scheduler may then communicate such information to the server-side global scheduler, which decides which applications are given which licenses and when, in a manner, for example, that ensures fairness and prevents starvation and deadlock.

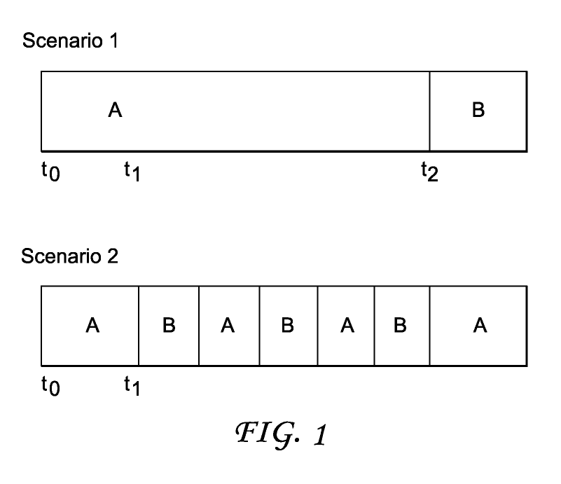

FIG. 1 shows application usage timelines illustrating starvation and non-starvation between users of a shared-license management system. Scenario 1 illustrates the greedy running process (GRP) starvation scenario typically encountered in traditional COCI systems. User A starts a long-running license-holding job at time t₀. Shortly thereafter, at time t₁, user B wants to start a job that needs the same license instance as user A. But before user B can begin, it must wait for a potentially long time until user A finishes at time t₂.

Scenario 2 contemplates the same two users, A and B, where each user requires the use of a shared-license application according to the various embodiments. Again, user A starts a long-running license-holding job at time t₀, and shortly thereafter, at time t₁, user B wants to start a job that needs the same license instance as user A. Unlike in Scenario 1, however, as soon as user B wants to start the job, the global scheduler ensures that users A and B timeshare the single license for as long as they both need it.

In one embodiment, the global scheduler may ensure that users A and B timeshare the single license by specifying a quantum of CPU time for each license grant. For example, an application may run only if it can run per the existing kernel scheduler semantics, and if it currently has assigned to it a nonzero remaining quantum of CPU time for all the licenses that it currently needs. When the remaining license quantum reaches zero, the application may not run until it gets another license quantum, or until the application declares that it no longer needs any licenses.

Further, to prevent a greedy idle process (GIP) scenario, the global scheduler may keep track of how long each process has been idle. For example, when the idle time exceeds a pre-selected value, the global scheduler may force the process to relinquish its license quantum. When the process eventually wakes up (i.e., becomes non-idle), the global scheduler may then reissue the needed licenses to the process. Moreover, whenever an application holding a license terminates (normally or unexpectedly) before it gets a chance to return a license, the global scheduler may automatically relinquish the process's remaining license quantum, thereby preventing a greedy dead process (GDP) scenario.

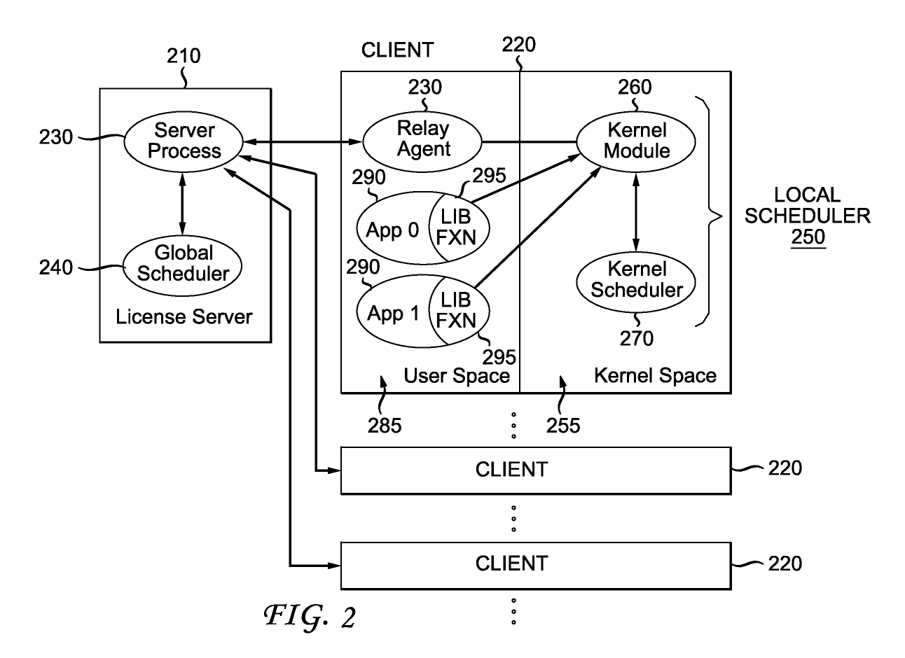

The architecture of the shared-license management system according to the various embodiments is shown in FIG. 2. The system 200 comprises a license server 210 and one or more clients 220. The license server 210 is in communication with the one or more clients 220, and can perform the job of scheduling the distribution of available licenses among the one or more clients 220 that need them.

The license server 210 comprises a server process 230 and a global scheduler 240, both in user space. In one embodiment, the server process 230 may call the global scheduler 240 in response to a license request received from the one or more clients 220. The global scheduler 240, in response to a call from the server process 230, may then schedule and grant license instances (i.e., quanta of CPU time) to the remote client processes.

Each client 220 in communication with the license server 210 comprises a local scheduler 250. The local scheduler 250 schedules local processes to client CPUs. In exemplary embodiments, the local scheduler 250 may be adapted to run in the existing client kernel space 255. For example, in order to minimize the number of existing kernel modifications, the local scheduler 250 may be implemented in two parts: a loadable kernel module 260 that communicates with a modified version of the default kernel scheduler 270 already present in the client kernel 255, and a relay agent 280 in user space 285 that enables the local scheduler 250 to communicate with the server 210. Each licensed application 290 running in user space 285 that wishes to obtain a license may compile and link to a library function 295. For example, when an application 290 needs a license, it may call a library function 295 and pass the library function 295 the known identifier for the license. The library function 295 may then write the corresponding license request to a device file within the kernel module 260.

In one embodiment, the global scheduler 240 comprises a global scheduling algorithm that may use an “any-out” variant of first-in-first-out (FIFO) ordering to establish a license-reservation queue. In the any-out ordering variation, the global scheduler 240 may only add processes to the rear of the queue, but is able to remove processes from anywhere in the queue. Moreover, once a process is in the queue, it is never moved with respect to the other processes in the queue.

The global scheduler 240 employing the any-out ordering variation maintains a queue, Q, for client processes that are waiting for grants for additional licenses. In one embodiment, the global scheduler 240, when invoked, may attempt to reserve all the needed-but-not-yet-reserved license instances for all the processes in the queue, starting at the front of the queue. License instances that cannot be reserved in a present scheduler invocation (e.g., the needed license instance is reserved by a process higher-up in the queue) may be skipped to eventually be reserved in a future invocation. When a process's reservations finally matches its need set, the global scheduler 240 removes that process from the queue and issues that process a (single) grant for the particular ensemble of licenses in the need set. When the process eventually returns the (fully or partially consumed) grant to the server 210, the global scheduler 240 adds the process to the rear of the queue, and the license instances in that grant's ensemble again become available for reservation. Further, the global scheduler 240 may clear out all of a process's reservations, wherever they are in the queue, when the scheduler determines that a process has become idle (i.e., to prevent a GIP scenario).

As such, for each process, p, the global scheduler 240 may maintain a need set, Np, consisting of the global scheduler's 240 current view of the process's need set. The global scheduler 240 may also maintain a reservation set, Rp, consisting of those license instances that are currently reserved to p. If a process is not in the queue, then Rp is empty. A free set, F, containing all license instances that the server 210 owns but are not currently reserved to any process or in use by any client is also maintained by the global scheduler 240. Therefore, Rp and F contain license instances, and Np contains license instance needs.

For each issued grant, g, the global scheduler 240 may maintain an ensemble, Eg, consisting of the license instances for which g was granted. The global scheduler 240 may maintain a granted set G containing all those processes that currently have an outstanding grant. In addition, the global scheduler 240 may maintain an idle set, I, containing all those processes that have been declared idle by their local scheduler. As such, at any given time a given process, p, is in at most one of the sets Q, G, or I.

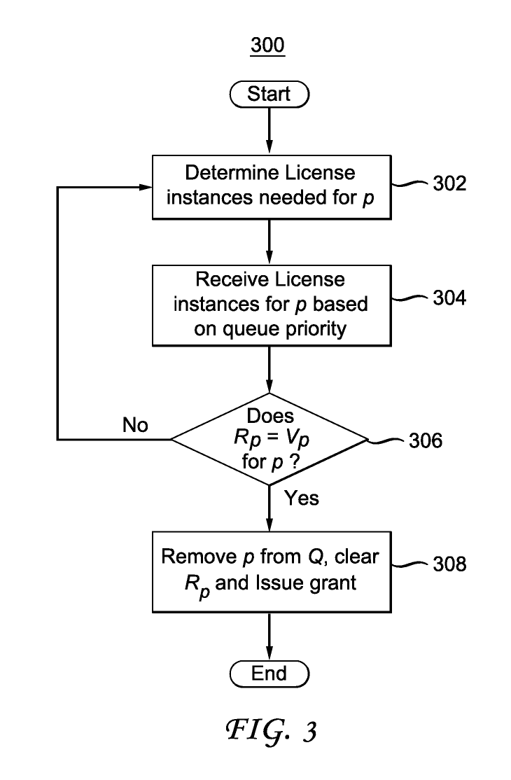

Given the sets Q, G and I, an invocation of the global scheduling algorithm, GSCHED, works as shown in FIG. 3. For each process p in the queue, at step 302 the global scheduler determines from the set, Np-Rp, those license instances that p needs but has not yet had reserved. At step 304, the global scheduler 240 attempts to reserve, if currently free, all the needed-but-not-yet-reserved license instances during a scheduler invocation. If these reservations cause p's reservations to match its need set at step 306, then the global scheduler 240 removes p from the queue, clears out p's reservations, and issues a grant to the appropriate client 220 at step 308. If the reservations do not yet cause p's reservation set to match its need set, the method returns to step 302 for the next scheduler invocation.

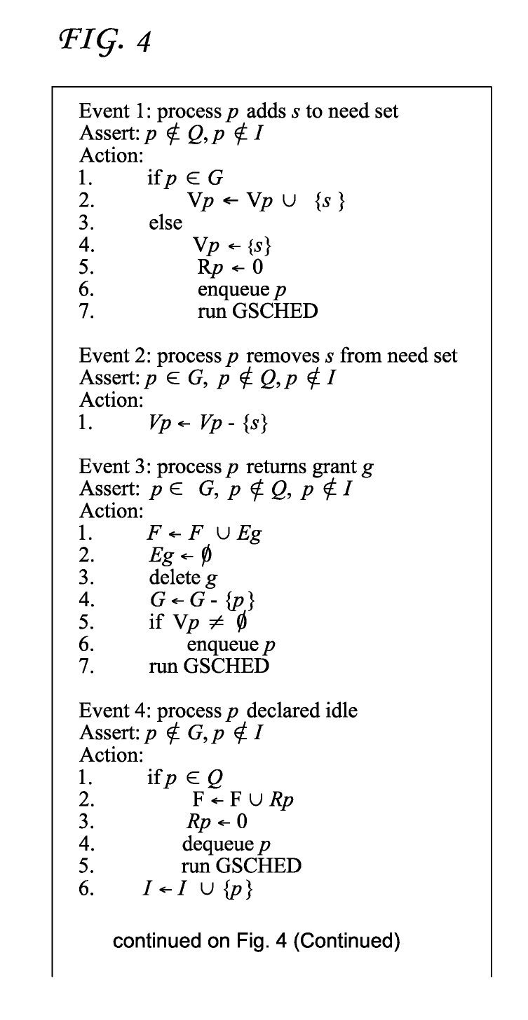

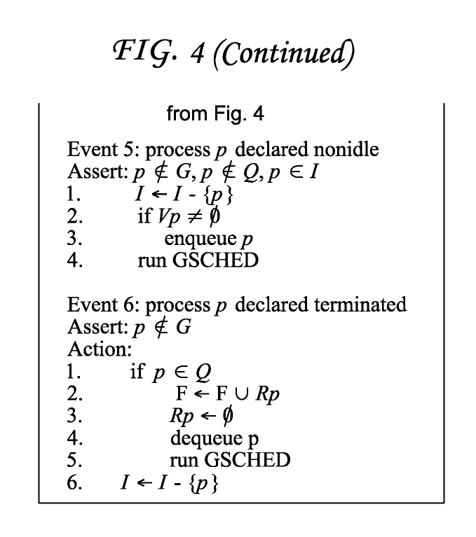

The global scheduler may handle various asynchronous events as illustrated by the event tables in FIG. 4. In one embodiment, all incoming events are queued in an event queue (not shown) and processed one at a time in the order in which they arrived. For example, when a process p requests an addition to its need set as illustrated by Event 1, it might already have a grant. If so, the global scheduler 240 may simply update the need set. (The local scheduler will quickly return that grant, because its ensemble does not include the newly requested license instance.) On the other hand, the process p may not have a grant. However, for p to have issued the need-set request, p must have been executing. As such, the local scheduler 250 may ensure that a grantless executing process has an empty need set. As a process with an empty need set cannot be on Q, the global scheduler may, when the license request is received, initialize Np and Rp, and add p to the queue. At the next scheduler invocation, the global scheduler 240 may run GSCHED for process p. Then, when process p makes a request to remove a license instance from its need set as shown in Event 2, the global scheduler 240 updates Np and no other action is required.

When a grant, g, is returned to the server 210 as shown in Event 3, the global scheduler 240 transfers all the license instances in that grant's ensemble Eg to F. If the process still needs any licenses, then the global scheduler 240 adds the process to the queue and, because F has changed, GSCHED is run.

In another embodiment illustrated in Event 4, before the local scheduler 250 declares a process p idle, it first returns any outstanding grant to the server 210. If the now-idle p is still in queue, then the global scheduler 240 may free all its reserved license instances, remove p from the queue, and run GSCHED. When p wakes up and becomes non-idle, if it still needs any licenses, the global scheduler 240 may return p to the queue and run GSCHED as illustrated by the code in Event 5. In Event 6, before the local scheduler 250 declares a process p is terminated, the global scheduler 240 recovers p's reservations, removes p from the queue, and runs GSCHED.

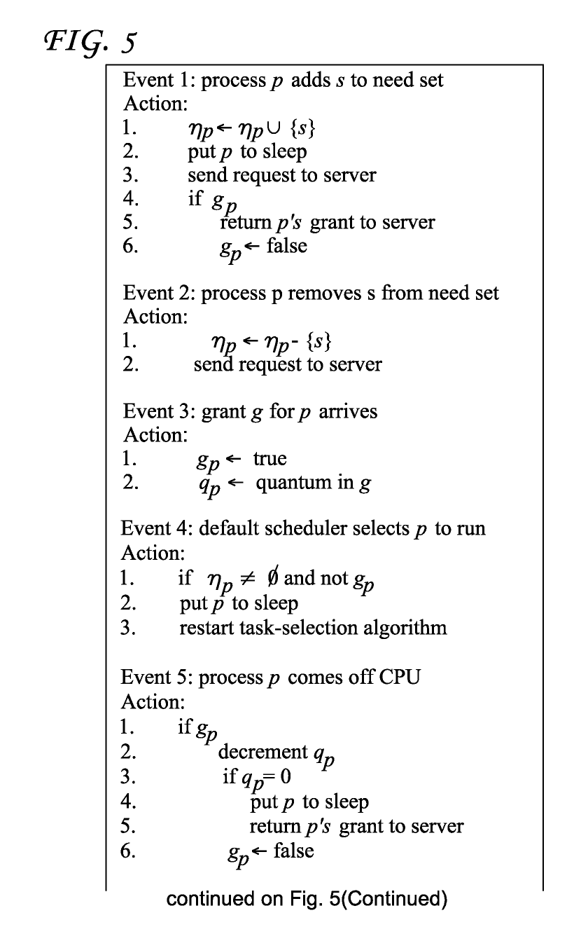

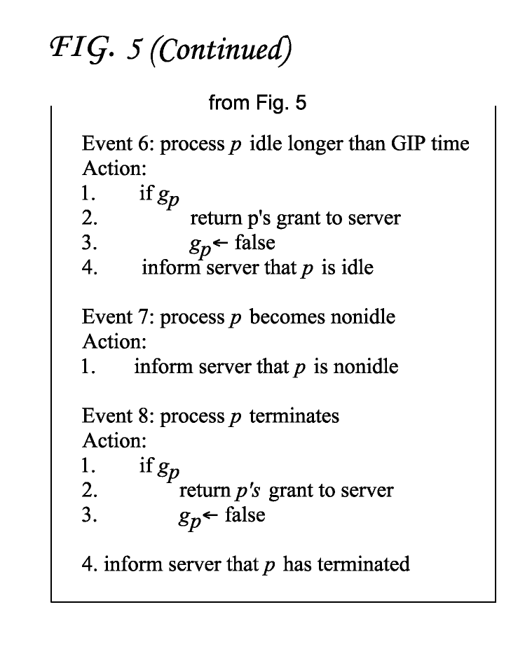

The local scheduler 250, like the global scheduler 240, is event driven. The local scheduler 250 may handle various asynchronous events as illustrated by the event tables in FIG. 5. In one embodiment, all incoming events are processed one at a time in the order they arrive. For example, when a process p requests another license instance, the kernel module 260 updates the process's actual current need set nₚ, puts p to sleep, and relays the request (through the relay agent 230) to the license server 210, as illustrated by Event 1. If p has a grant, this grant is returned to the license server 210, because it is possible that the grant's ensemble no longer includes all of the needed license instances for p.

When p makes a request to remove a license instance from its need set, as illustrated by Event 2, the kernel module 260 updates nₚ and relays the request to the license server 210. As illustrated by Event 3, when a grant gₚ arrives for p, the kernel module 260 stores the grant. In one embodiment, the local scheduler 250 may behave the same as the global scheduler 240 in terms of process-scheduling behavior, with a single exception: the local scheduler 250 may allow a license-needing process to run only if it has a license grant—that is, a nonzero unused quantum that is good for all the licenses in the current need set. If p needs but does not have a grant, then p is put to sleep and the kernel module 260 restarts the task-selection algorithm, as illustrated by Event 4. For example, whenever a process comes off the CPU, the kernel module 260 may be called to decrement the unused quantum, and if the quantum is consumed, to put the process to sleep and return the grant to the server 210, as illustrated by Event 5. In one embodiment, the kernel scheduling modification may be implemented by inserting a small number of hooks into the default kernel scheduler 270 to minimize the number of kernel modifications, wherein these hooks make calls into the kernel module to perform the process-scheduling specific logic.

In another embodiment, whenever a process has been idle for longer than a specified GIP time, as illustrated by Event 6, the kernel module 260 may be called to return any outstanding grant to the server 210 and to inform the server 210 that the process is idle. When the process becomes non-idle (Event 7), the kernel module 260 may be called to inform the server 210 of that fact. Further, whenever a process exits or dies, the kernel module 260 may be called to return any outstanding grant to the server 210 as illustrated by Event 8.

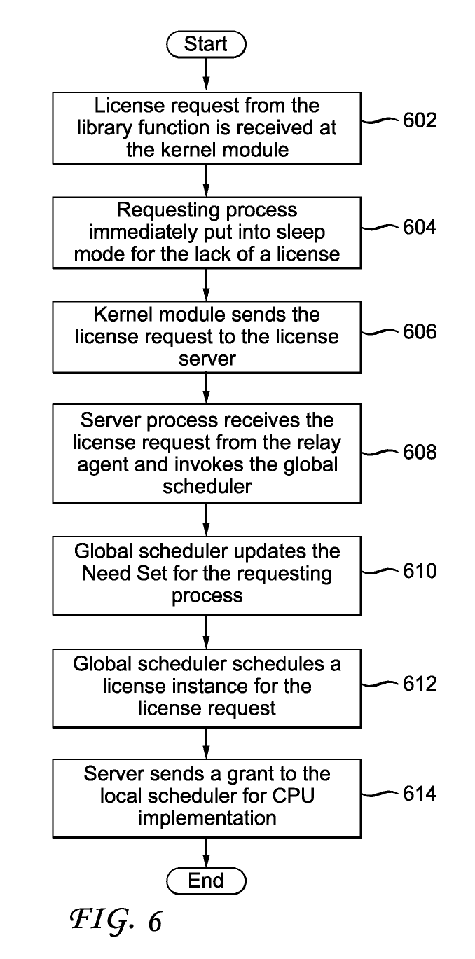

FIG. 6 is a flowchart showing the steps taken for implementing a distributed license management system according to the various embodiments. When the license request from the library function 295 is received at the kernel module 260 portion of the local scheduler 250 at step 602, the local scheduler 250, at step 604, causes the requesting process to be immediately put into sleep mode for the lack of a license.

At step 606, the kernel module 260 sends the license request to the license server 210 via the relay agent 280. The relay agent 280 may be in communication with the license server 210 via, for example, a high-speed LAN or other wired or wireless communications link.

At step 608, the server process 230 receives the license request from the relay agent 280 and invokes the global scheduler 240. As described above, the global scheduler 240 maintains a data structure that lists the need set for every process on every connected client machine. For example, when the server 210 receives a process's license request, at step 610 the global scheduler 240 updates the need set for the requesting process. The global scheduler may then schedule a license instance, or quantum allocation, for the license request based on the need set maintained in the data structure at step 612. In various embodiments, a single quantum allocation may be good for a particular license request or, in the alternative, a particular ensemble of licenses that are currently contained in the process's need set. When all of the license instances for the process's need set are obtained, at step 614, the server 210 sends a grant to the local scheduler 250 for CPU implementation.

In one embodiment, once the global scheduler 240 issues a quantum allocation grant, it will not issue another grant to that process until the process is done with the outstanding grant and returns it to the server. For example, the local scheduler 250 may maintain, for each process executing on that machine, the process's need set and whether that process has an outstanding grant. If the latter is true, then the local scheduler 250 may also record the remaining unused license quantum. When the local scheduler 250 receives the grant, it updates the process's unused quantum, and the process may run per, for example, the OS scheduling algorithm. Each time the process receives a share of the CPU, the local scheduler 250 decrements the process's unused license quantum. If the unused quantum become zero as a result, the process may again cease to run, and the local scheduler 250 may return the grant to the server 210. Eventually, the server 210 may issue the process a new grant, and the process will once again be able to run.

If a licensed software application needs an additional license, the process may return to step 602 in which the application calls a library function which the local scheduler 250 may add to the process's need set and, after the process is put into sleep mode at step 604, the relevant information is processed at the server 210 as in steps 608 to 614. If the process has an outstanding grant, the local scheduler 250 may return it to the server 210, because that grant no longer covers all licenses in the need set.

In one embodiment, when an application no longer needs a license, the application calls a library function to pass the relevant information to the local and global schedulers, which remove that license from the process's need set. Further, when the local scheduler 250 determines that a process has been idle for longer than a configurable GIP period, the local scheduler 250 may return any outstanding grant to the server 210 and may inform the server 210 that the process has become idle. The global scheduler 240 may not issue any grants to idle processes during the idle period. When the process becomes non-idle, the local scheduler 250 may inform the server 210, which may then resume issuing grants to the process in the manner described above.

When a process terminates for any reason, both schedulers may remove that process from their data structures. As such, the license server 210 may be configured to periodically monitor the status of connected clients and their processes. For example, the server process 230 may run the global scheduler 240 whenever the set of connected clients 220 changes and whenever a process executing on a client 220 requires that the global scheduler 240 be run - such as whenever a process returns a grant, changes its need set, changes its idle state, or terminates. As soon as the server process 230 learns of these events, it may re-run the global scheduler 240 and communicate the results to the clients 220.

In another embodiment, if the local scheduler 250 encounters a network partition, e.g., the client 220 becomes temporarily disconnected from the license server 210, both license requests and consumed licenses may not be immediately returned to the server 210. Rather, the local scheduler 250 may queue license requests and consumed license grants at the client 220 until network connectivity is restored.

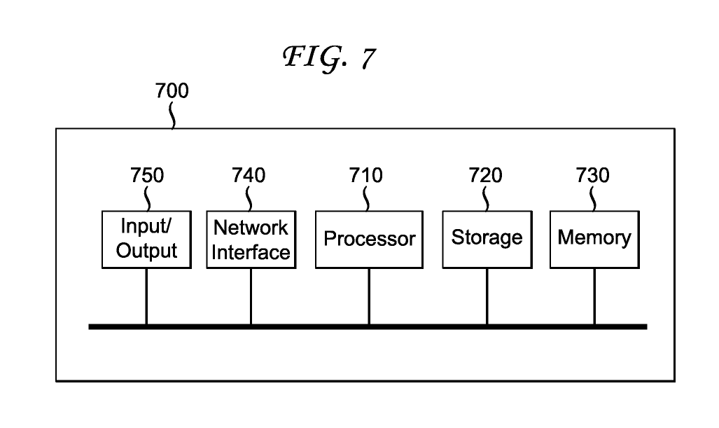

The above-described methods may be implemented on a computer using well-known computer processors, memory units, storage devices, computer software, and other components. A high-level block diagram of such a computer is illustrated in FIG. 7. Computer 700 contains a processor 710, which controls the overall operation of the computer 700 by executing computer program instructions which define such operation. The computer program instructions may be stored in a storage device 720 (e.g., magnetic disk) and loaded into memory 730 when execution of the computer program instructions is desired. Thus, the steps of the method of FIGS. 3 and 6 may be defined by the computer program instructions stored in the memory 730 and/or storage 720 and controlled by the processor 710 executing the computer program instructions. The computer 700 may include one or more network interfaces 740 for communicating with other devices via a network for implementing the steps of the method of FIGS. 3 and 6. The computer 700 may also include other input/output devices 750 that enable user interaction with the computer 700 (e.g., display, keyboard, mouse, speakers, buttons, etc.). One skilled in the art will recognize that an implementation of an actual computer could contain other components as well, and that FIG. 7 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

We claim:

1. A method comprising:
receiving from a remote client a license request to run a process of a shared-license application;
adding the process to a queue maintained for processes waiting for license grants; and
reserving at least one license instance for the received license request, the at least one license instance comprising a quantum of CPU time for running the process.

2. The method of claim 1, wherein the process is added to the rear of the queue, and the queue is ordered according to an any-out method where processes requesting licenses are not moved with respect to each other.

3. The method of claim 1, further comprising maintaining a reservation set for each process in the queue, wherein the reservation set includes all reserved license instances for the process.

4. The method of claim 3, further comprising maintaining a need set for each process in the queue, wherein the need set includes all received license requests for the process.

5. The method of claim 4, further comprising determining from the need set at least one license instance that the process needs but has not yet had reserved.

6. The method of claim 4, further comprising reserving a plurality of license instances for the requesting process based on the process's need set.

7. The method of claim 4, further comprising removing the process from the queue when the process's reservation set matches the process's need set.

8. The method of claim 1, further comprising issuing a grant including the at least one license instance to the remote client.

9. The method of claim 1, further comprising relinquishing all of the reserved license instances for the process if the process has been idle for a time that exceeds a pre-selected value.

10. The method of claim 9, further comprising reissuing the reserved license instances to the process when the process becomes non-idle.

11. The method of claim 1, further comprising relinquishing all of the reserved license instances for the process if the process has terminated.

12. The method of claim 1, further comprising idling the process if the process does not currently have at least one reserved license instance.

13. A global scheduler, comprising:
a data interface configured to receive a license request from a remote client to run a process of a shared-license application;
a memory configured to store the license request; and
a processor in communication with the memory, the processor configured to:
add the process to a queue maintained for processes waiting for license grants; and
reserve at least one license instance for the received license request, the at least one license instance comprising a quantum of CPU time for running the process.

14. The global scheduler of claim 13, wherein the processor is further configured to add the process to the rear of the queue, and wherein the queue is ordered according to an any-out method where processes requesting licenses are not moved with respect to each other.

15. The global scheduler of claim 13, wherein the processor is further configured to maintain a reservation set for each process in the queue, and wherein the reservation set includes all reserved license instances for the process.

16. The global scheduler of claim 15, wherein the processor is further configured to maintain a need set for each process in the queue, and wherein the need set includes all received license requests for the process.

17. The global scheduler of claim 15, wherein the processor is further configured to determine from the need set at least one license instance that the process needs but has not yet had reserved.

18. The global scheduler of claim 15, wherein the processor is further configured to reserve a plurality of license instances for the requesting process based on the process's need set.

19. The global scheduler of claim 15, wherein the processor is further configured to remove the process from the queue when the process's reservation set matches the process's need set.

20. The global scheduler of claim 13, wherein the processor is further configured to issue a grant including the at least one license instance to the remote client.

21. The global scheduler of claim 13, wherein the processor is further configured to relinquish all of the reserved license instances for the process if the process has been idle for a time that exceeds a pre-selected value.

22. The global scheduler of claim 21, wherein the processor is further configured to reissue the reserved license instances to the process when the process becomes non-idle.

23. The global scheduler of claim 13, wherein the processor is further configured to relinquish all of the reserved license instances for the process if the process has terminated.

24. The global scheduler of claim 13, wherein the processor is further configured to idle the process if the process does not currently have at least one reserved license instance.

25. An article of manufacture including a non-transitory computer-readable medium having instructions stored thereon, that in response to execution by a computing device causes the computing device to perform operations comprising:
receiving from a remote client a license request to run a process of a shared-license application;
adding the process to a queue maintained for processes waiting for license grants; and
reserving at least one license instance for the received license request, the at least one license instance comprising a quantum of CPU time for running the process.
